(19) United States
(12) Patent Application Publication
(10) Pub. No.: US 2009/0184452 A1
(43) Pub. Date: Jul. 23, 2009

(54) Print Type Binder for Paper Money, System Including the Binder, and Motion Method Thereof

(76) Inventors: Mi Soon Yoo, Seoul (KR); You Seung Ok, Seoul (KR); Kee Hyun Shin, Gyeonggi-do (KR); Hyun Kyoo Kang, Gyeonggi-do (KR); Jin Woo Seong, Seoul (KR)

Correspondence Address: QUARLES & BRADY LLP, RENAISSANCE ONE, TWO NORTH CENTRAL AVENUE, PHOENIX, AZ, 85004-2391, US

(21) Appl. No.: 12/299,334

(22) PCT Filed: May 4, 2007
(86) PCT No.: PCT/KR2007/002194

§ 371 Date: Nov. 3, 2008

(30) Foreign Application Priority Data
May 4, 2006 (KR) 10-2006-0040629
Mar. 29, 2007 (KR) 10-2007-0030979

(51) Int. Cl. B41F 19/00; G06K 5/00; G05B 19/02; G05D 15/01; G08B 21/00

(52) U.S. Cl. 270/1.01; 235/382; 700/275; 700/301; 340/540

(57) ABSTRACT

A printer type paper money binding apparatus can print bundle-of-paper money information, such as a logo, the date, the money unit and the amount of money, on the binding strip, which is used to bind a bundle of paper money. A printer type paper money binding system capable of authenticating an operator and the operation method thereof can prevent an unauthorized operator from performing a printing and binding operation, thereby ensuring security in the printing and binding operation.

### TECHNICAL FIELD

The present invention relates to a printer type paper money binding apparatus, which can print information about a bundle of paper money (bundle-of-paper money information), such as a logo, date, money unit and amount of money, on a binding strip, which is used to bind the bundle of paper money.

### BACKGROUND ART

Techniques for paper money binding apparatuses are disclosed in a plurality of patent applications and patents including Korean Published Patent Application No. 2000-0074599 (entitled “PAPER MONEY BINDING APPARATUS”). The paper money binding apparatus in this document includes one ribbon pass block 21, front and rear ribbon pass covers 22 and 23, X-bar association units and bar-driving units. The ribbon pass block 21 is configured to stably support a heat assembly 3, and the front and rear ribbon pass covers 22 and 23 are combined with two ends of the ribbon pass block 21 together with upper and lower fixing rods 27. The X-bar association units are arranged aside the front and rear ribbon pass covers 22 and 23 to spread and restore the front/rear ribbon pass covers 22 and 23 away from/back toward the ribbon pass block 21. The bar-driving units are arranged opposite each other, above and under a bending plate 17, and perform a line or surface contact with a paper money binding surface, which is in surface contact with the bending plate 17, to press the paper money binding surface.

However, the earlier-filed patent applications and techniques related with common paper money binding apparatuses merely involve binding paper money in a bundle using a binding strip. Thus, it is not easy for an operator to get information about a bundle of paper money.

Furthermore, conventional techniques do not afford safe security measures, which can block an unauthorized person from using the paper money binding apparatus.

### DISCLOSURE OF INVENTION

### Technical Problem

Therefore, the present invention has been made in view of the above-mentioned problems.

An object of the present invention is to provide a printer type paper money binding apparatus which can print bundle-of-paper money information, including a logo, date, money unit and amount of money, on a binding strip, which is used to bind the bundle of paper money, so that an operator can easily get information related to the bundle of paper money.

A further object of the present invention is to provide a printer type paper money binding apparatus which can automate a process of inputting a bank name and necessary data in order to improve working efficiency and reduce maintenance costs.

A further object of the present invention is to provide a printer type paper money binding apparatus which can transmit/receive information to/from an external device via an interface part, and thereby can be integrated or associated with a financial accounting system.

A further object of the present invention is to provide a printer type paper money binding apparatus which can be controlled in such a manner as to leave no unused binding strip, which is already printed, inside the binding apparatus, in order to prevent another operator from using the printed unused binding strip, and thus to prevent an error in paper money records and theft/use for bad purposes, thereby enhancing apparatus security.

A further object of the present invention is to provide a printer type paper money binding apparatus which can ensure security in a binding operation by allowing only an authenticated operator to use the paper money binding apparatus.

A further another object of the present invention is to provide a printer type paper money binding apparatus which can generate a warning signal or notify of inconsistencies to a designated external device via a communication network, which is connected by an interface part, if an unauthenticated person is attempting to perform a printing and binding operation.

A further object of the present invention is to provide a printer type paper money binding system capable of authenticating an operator and an operation method thereof, which can scan a security card having an ID tag, where operator identification information is stored, in order to prevent an unauthorized operator from performing a printing and binding operation, thereby ensuring security in the printing and binding operation.

A further object of the present invention is to provide a printer type paper money binding system capable of authenticating an operator and an operation method thereof, which can generate a warning signal or automatically notify of inconsistencies to a security company via a communication network if operator information, stored in a memory of the paper money binding system, is forged or deleted without authority.

Yet another object of the present invention is to provide a printer type paper money binding system capable of authenticating an operator and an operation method thereof, which can identify an operator and print operator identification information, associated institution name, date and working site, when binding paper money (including securities and stocks) and important documents in a financial institution or a public office, in order to fundamentally prevent any unfaithfulness of the operator as well as easily track the flow of the bound paper money or documents.

### Technical Solution

According to an aspect of the invention, the invention provides a printer type paper money binding apparatus, comprising: a power supply; a binding strip storing part for receiving binding strips for binding paper money; a printer for printing bundle-of-paper money information on a binding strip introduced from the binding strip storing part; a binder for binding paper money using the binding strip, on which the bundle-of-paper money information is printed; a memory storing various types of information including information necessary for printing the bundle-of-paper money information on the binding strip and binding the paper money; and a controller for controlling the power supply, the binding strip storing part, the printer, the binder and the memory together with components, which are necessary for printing the bundle-of-paper money information on the binding strip and binding the paper money.

Preferably, the printer type paper money binding apparatus further comprises: an input part for inputting the various types of information stored in the memory, or operation instruction signals inputted into the controller; or an interface part associated with an external device to transmit/receive the information stored in the memory, or the operation instruction signals inputted into the controller, to/from external device.

Preferably, the printer type paper money binding apparatus further includes an input part for inputting various types of information stored in the memory, or operation instruction signals inputted into the controller; and an interface part associated with an external device to transmit/receive the information, stored in the memory, or the operation instruction signals, inputted into the controller, to/from external device.

Preferably, the printer comprises: a counter module for measuring present date and time; and a printer module for receiving the bundle-of-paper money information from the memory and printing the bundle-of-paper money information on the binding strip.

Preferably, the printer type paper money binding apparatus further includes a sensor for detecting pressure on the binding strips ejected from the printer, wherein the controller controls an operation of the printer based upon a detection signal from the sensor in order to adjust an amount of the binding strips, which are accumulated, thereby preventing damage to the binding strips.

Preferably, the printer type paper money binding apparatus further includes a display for displaying the various types of information, including the bundle-of-paper money information stored in the memory.

Preferably, the display has a function of a touch screen.

Preferably, the controller controls the apparatus to discharge a remaining portion of the binding strips which are already printed but not used yet, when the power supply is turned off.

Preferably, the controller controls the printer and the binder to consume a remaining portion of the binding strips which are already printed but not used yet, even though a stop signal is inputted.

Preferably, the various types of information stored in the memory further comprise operator authentication information of operators who are allowed to perform a printing and binding operation using the printer type paper money binding apparatus.

Preferably, the operator authentication information stored in the memory comprises a password or bio-information.

Preferably, the printer type paper money binding apparatus further comprises an alarm for generating a warning signal if the operator authentication information stored in the memory is not identical to information, which is inputted through the input part or the interface part.

Preferably, the controller sends an inconsistency signal to a designated external device via a communication network, the controller connected to the communication network by the interface part, if the operator authentication information, stored in the memory, is not identical with information, which is inputted through the input part or the interface part.

Preferably, the controller makes a control to perform the printing and binding operation only if the operator authentication information stored in the memory is identical to information which is inputted through the input part or the interface part.

According to another aspect of the invention, the invention provides a printer type paper money binding system capable of authenticating an operator, including a security card having an identification (ID) tag storing operator information including printing-binding operator information and operator authentication information; and a printer type paper money binding apparatus including: an ID tag receiver for receiving the operator information, stored in the ID tag, via a contact or non-contact method; a memory storing various types of information including operator information of operators, who are allowed to perform a printing and binding operation, and information necessary for printing bundle-of-paper money information and binding paper money; and a controller for comparing the operator information, stored in the ID tag of the security card, with the operator information stored in the memory, in order to control components which are necessary for printing the bundle-of-paper money information on a binding strip and binding the paper money, based upon consistency between the operator information stored in the ID tag of the security card, and the operator information stored in the memory.

Preferably, the controller makes a control to generate a warning signal or automatically send an inconsistency signal to a designated device via a communication network if the operator information stored in the memory is forged or deleted without authority during the operation of binding the paper money.

Preferably, the controller sends an inconsistency signal to a security company via a communication network if the operator information stored in the ID tag of the security card is not identical with the operator information stored in the memory.

Preferably, the binding strip is printed with operator identification information, bank name, date and branch office name.

Preferably, the ID tag is a radio frequency identification (RFID) tag, and the ID tag receiver is an RFID tag receiver.

According to further another aspect of the invention, the invention provides a method of operating a printer type paper money binding system capable of authenticating an operator, which comprises a security card having an identification tag inserted therein and a printer type paper money binding apparatus, including steps of: (a) at an ID tag receiver of the paper money binding apparatus, receiving operator information including operator identification information and authentication information stored in the ID tag of the security card; (b) comparing the operator information stored in the ID tag of the security card with operator information of operators, who are allowed to perform a binding and binding operation, stored in the memory; and (c) controlling an authority over the money binding apparatus based upon a result of the comparing step (b) in order to carry out the printing and binding operation.

Preferably, the method further includes generating a warning signal and stopping a process if the operator information stored in the ID tag of the security card is not identical with the operator information stored in the memory as the result of the comparing step (b).

Preferably, the method further includes sending an inconsistency signal to a security company server via a communication network if the operator information stored in the ID tag of the security card is not identical with the operator information stored in the memory as the result of the comparing step (b).

Preferably, the method includes printing the operator identification information of the operator information and information, including bank name, date and branch office name, on a binding strip and binding paper money with the printed binding strip if the operator information stored in the ID tag of the security card is identical with the operator information stored in the memory as the result of the comparing step (b).

### ADVANTAGEOUS EFFECTS

The present invention has positive effects as follows:

According to the printer type paper money binding apparatus of the present invention, it is possible to print bundle-of-paper money information, including a logo, the date, the money unit and the amount of money, on a binding strip which is used to bind the bundle of paper money, so that an operator can easily get information related with a bundle of paper money.

According to the printer type paper money binding apparatus of the present invention, it is possible to automate a process of inputting a bank name and necessary data in order to improve working efficiency and reduce maintenance costs.

According to the printer type paper money binding apparatus of the present invention, it is possible to transmit/receive information to/from an external device via an interface part, and thereby be integrated or associated with a financial accounting system.

According to the printer type paper money binding apparatus of the present invention, the apparatus can be controlled in such a manner as to leave no unused binding strip, which is already printed, inside the binding apparatus, in order to prevent another operator from using the printed unused binding strip, and thus to prevent an error in paper money records and theft/use for bad purposes, thereby enhancing apparatus security.

According to the printer type paper money binding apparatus of the present invention, it is possible to ensure security in a binding operation by allowing only an authenticated operator to use the paper money binding apparatus.

According to the printer type paper money binding apparatus of the present invention, it is possible to generate a warning signal or notify inconsistency to a designated external device via a communication network, which is connected by an interface, if an unauthenticated person is attempting to perform a printing and binding operation.

According to the printer type paper money binding system capable of authenticating an operator and an operation method thereof of the present invention, it is possible to use a security card having an ID tag, where operator identification information is stored, in order to prevent an unauthorized operator from performing a printing and binding operation, thereby ensuring security in the printing and binding operation.

According to the printer type paper money binding system capable of authenticating an operator and an operation method thereof of the present invention, it is possible to generate a warning signal or automatically notify inconsistency to a security company via a communication network if operator information stored in a memory of the paper money binding system is forged or deleted without authority.

According to the printer type paper money binding system capable of authenticating an operator and an operation method thereof of the present invention, it is possible to identify an operator and print operator identification information, the associated institution name, the date and the working site, when binding paper money (including securities and stocks) and important documents in a financial institution or a public office, in order to fundamentally prevent any unfaithfulness of the operator as well as easily track the flow of the bound paper money or documents.

### BRIEF DESCRIPTION OF THE DRAWINGS

FIG. 1 is a perspective view illustrating a conventional paper money binding apparatus;

FIG. 2 is a block diagram illustrating a printer type paper money binding apparatus according to a first embodiment of the invention;

FIG. 3 is a block diagram illustrating a printer type paper money binding apparatus according to a second embodiment of the invention;

FIG. 4 is a flowchart illustrating a process of removing a binding strip, which is printed but not used yet in the printer type paper money binding apparatus of the present invention;

FIG. 5 is a broken side elevational view illustrating the printer type paper money binding apparatus according to the first embodiment of the present invention, in which binding strips ejected from a printer of the paper money binding apparatus are introduced to a binder;

FIG. 6 is a broken side elevational view illustrating the printer type paper money binding apparatus according to the first embodiment of the present invention, in which binding strips are accumulated inside the paper money binding apparatus;

FIG. 7 is a broken side elevational view illustrating the printer type paper money binding apparatus according to the second embodiment of the present invention, in which binding strips are introduced into a binder through a sensor;

FIG. 8 is a perspective view illustrating the printer type paper money binding apparatus shown in FIG. 7, in which a nest is configured to support the binding strips ejected from the printer;

FIG. 9 is a perspective view illustrating the printer type paper money binding apparatus shown in FIG. 7, which includes an input part, an interface part and a display;

FIG. 10 is a broken side elevational view illustrating the printer type paper money binding apparatus shown in FIG. 7, in which a binding strip storing part and a printer are relocated to provide first and second guide blocks;

FIG. 11 is a block diagram illustrating a printer type paper money binding system capable of authenticating an operator using a security card with an ID tag inserted therein;

FIG. 12 is a flowchart illustrating a process of the printer type paper money binding system capable of authenticating an operator using a security card having an ID tag inserted therein; and

FIG. 13 is a reference view illustrating an exemplary binding strip, where an example of bundle-of-paper money information used in a printer type paper money binding apparatus of the present invention is printed, and a bundle of paper money bound using the same binding strip.

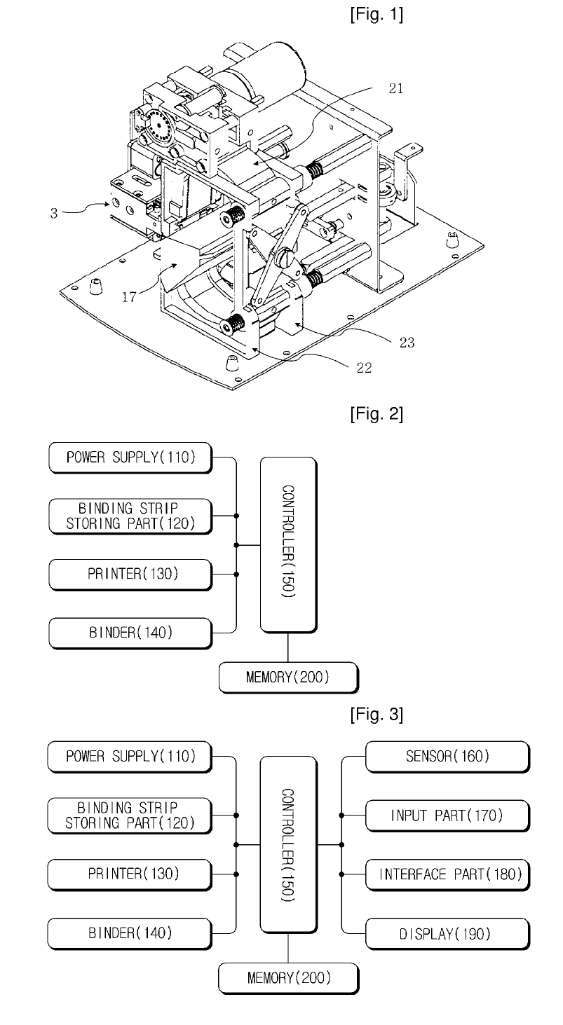

### MAJOR REFERENCE SIGNS OF THE DRAWINGS

1: printer type paper money binding system

10: security card 11: ID tag

100: printer type paper money binding apparatus

110: power supply

120: binding strip storing part 130: printer

140: binder 150: controller

160: sensor 170: input part

180: interface part 190: display

200: memory 210: ID tag receiver

### MODE FOR THE INVENTION

The above and other objects, features and other advantages of the present invention will be more clearly understood from the following detailed description taken in conjunction with the accompanying drawings. Herein, it should be understood that the terms and words used throughout the specification and the claims are selected by the inventors as being most indicative of the technical idea of the present invention based upon the principle that the inventor can properly define the terms in order to explain the present invention.

The present invention will now be described in detail with reference to the accompanying drawings.

In a configuration view illustrating a printer type paper money binding apparatus according to an embodiment of the present invention, a binder is illustrated only with respect to major components thereof, since the binder includes some of known components and functions of the conventional binder that has been previously described in the earlier patent application.

Describing in greater detail with reference to the accompanying drawings, the printer type paper money binding apparatus 100 according to an embodiment of the present invention includes a power supply 110, a binding strip storing part 120, a printer 130, a binder 140, a memory 200 and a controller 150 as shown in FIG. 2.

The binding strip storing part 120 contains binding strips (also referred to as book bands or tapes) for binding paper money. The printer 130 prints information of a bundle of paper money (hereinafter will be referred to as bundle-of-paper money information), such as a desired logo, the date, the money unit and the amount of money, etc, on binding strips, which is introduced from the binding strip storing part 120. As an embodiment for realizing this, the printer 130 may include a counter module for measuring the present day and time and a printing module for receiving bundle-of-paper money information stored in the memory 200, and printing received bundle-of-paper money information on the binding strips.

In this embodiment, the printer 130 will be described to perform a typical dot printing method. However, it is not intended to limit the present invention. The present invention can adopt any of known printing methods, such as ink jet and thermal printing.

The binder 140 is a common paper money binding module, and when the paper moneys are introduced, acts to bind paper moneys using the binding strips where bundle-of-paper money information is printed.

The memory 200 stores data including information necessary for printing bundle-of-paper money information on the binding strips and information necessary for binding the paper moneys. While the memory 200 of this embodiment is implemented with a rewritable non-volatile memory, such as an EEPROM, it is not intended to limit the present invention. Herein, bundle-of-paper money information includes the bank name, the branch office name, the operator number, the date, and so on.

The controller 150 controls the aforementioned components designated with reference numbers 110, 120, 130, 140 and 200, as well as other components necessary for binding introduced paper money with the binding strips where bundle-of-paper money information is printed.

In particular, in the case where the power supply 110 is turned off, the controller 150 preferably controls related components to discharge unused remaining the binding strips where bundle-of-paper money information has been printed. When the unused printed binding strips are discharged, the operator must remove the discharged binding strips from the paper money binding apparatus 100 and discard the discharged binding strips in order to prevent the discharged binding strips from being used by another operator. The printed binding strips, if not discarded, may cause an error in paper money records or a misuse in a theft.

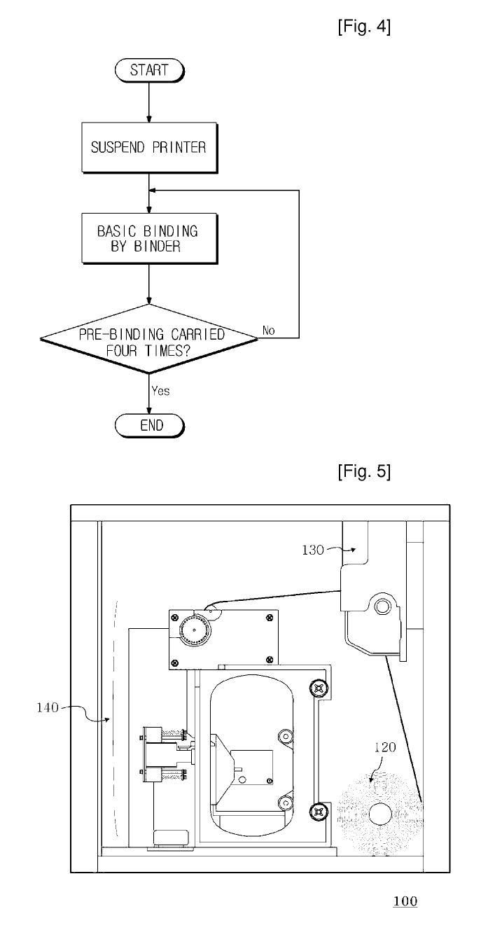

In addition, even if a stop signal is inputted, the controller 150 controls the printer 130 and the binder 140 to use the unused binding strips, which are already printed, as shown in FIG. 4. That is, the binder 140 is controlled to automatically bind paper money with the binding strips which has been already printed with bundle-of-paper money information but not used yet, in order to consume the printed unused binding strips. This is performed a predetermined number of times adequate for discharging the binding strips. (While the predetermined number of times is illustrated as four times, they may be varied according to printers.) Accordingly, it is possible to eliminate any possibilities that the unused binding strips which have been already printed with bundle-of-paper money information can be misused.

Referring to FIG. 3, a printer type paper money binding apparatus 100 according to another embodiment of the present invention further includes a sensor 160, an input part 170, an interface part 180 and a display 190 in addition to the power supply 110, the binding strip storing part 120, the printer 130, the binder 140, the memory 200 and the controller 150 as shown in FIG. 2. Herein, the printer type paper money binding apparatus 100 according to this embodiment may further include only any one of the sensor 160, the input part 170, the interface part 180 and the display 190. It is also possible to impart two functions to one component.

Describing the sensor 160 at first, the sensor 160 is arranged on an inner side surface of a housing adjacent to the binder 140 to detect a binding strip ejected from the printer 130 in order to adjust the operation of the printer 130.

That is, in the printer type paper money binding apparatus 100 as shown in FIG. 2, when binding strips are ejected from the printer 130 and introduced into the binder 140, the binding strips may be damaged by a force (tension or pressure) between the printer 130 and the binder 140. This damage can be overcome by introducing the binding strips into the binder 140 through a predetermined space between the printer 130 and the binder 140. However, the binding strips, accumulated inside the binding apparatus as shown in FIG. 6, may cause malfunctions.

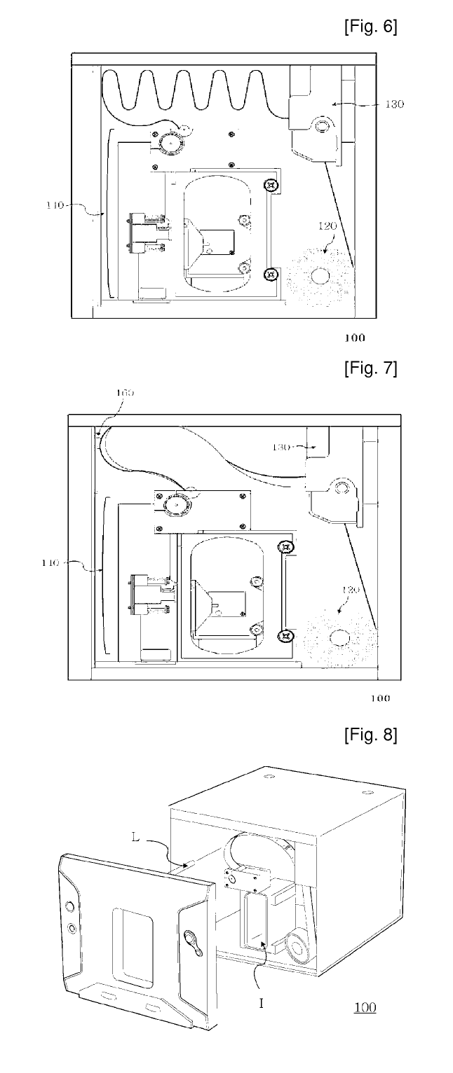

In order to overcome the aforementioned problem, the printer type paper money binding apparatus 100 of this embodiment further includes the sensor 160 arranged in the inner side surface of the housing adjacent to the binder 140 as shown in FIG. 7. In greater detail, when the sensor 160 detects tension in the binding strips located in the space between the printer 130 and the binder 140, the controller 150 stops the operation of the printer 130. When the tension is not detected, the controller 150 judges the binding strips to be not accumulated and controls the printer 130 to operate again. While the sensor 160 of this embodiment may be implemented with a pressure sensor, it is not intended to limit the present invention.

Alternatively, the printer type paper money binding apparatus 100 of this embodiment may further include a nest L, as shown in FIG. 8, for supporting the binding strips ejected from the printer. The nest L is extended from one side portion of the housing, which opposes a money inlet I, into the binding apparatus to a preset length.

FIG. 9 illustrates the input part, the interface part and the display of this embodiment. These components will be described with reference to FIG. 9, as follows:

The input part 170 serves to input data including bundle-of-paper money information stored in the memory 200 or operating instruction signals inputted in the controller 150. The input part 170 may be implemented with an input unit having a known structure, preferably, a key input unit as shown in FIG. 9, or a touch screen.

The interface part 180 is connected to external devices and transmits/receives the data stored in the memory 200, or the operating instruction signals inputted in the controller 150, to/from the external devices. The interface part 180 acts to transmit/receive the data including bundle-of-money information stored in the memory 200 and various external device information to/from the external devices. For example, the interface part 180 may receive new logos or letters from the external devices. Therefore, the interface part of this embodiment may be implemented with a USB port or an RS232 port, but it is not intended to limit the present invention. In addition, the printer type paper money binding apparatus 100 may be integrated or associated with a financial accounting system, which can collect, count, inspect and bind paper money through the interface part, or associated with a security company.

The display 190 displays various types of information such as information inputted through the input part 170 and the interface part 180, bundle-of-paper money information stored in the memory 200, and new logo and letter information. The display 190 of the present invention may be implemented with a known display unit such as a Cathode Ray Tube (CRT), an index mark display, a Plasma Display Panel (PDP), a Liquid Crystal Display (LCD), an electroluminescence (EL) device, a light emitting diode (LED), an electro chromatic display (ECD), and so on. The display 190 of the present invention may preferably have a function of a touch screen.

The input part 170, the interface part 180 and the display 190 as explained above may be integrated in their structures and functions. For example, the input part 170 and the interface part 180 may be occasionally integrated into one component or the input part 170 and the display 190 may be integrated into one component, such as a touch screen.

In the printer type paper money binding apparatus 100 of the present invention, the memory 200 may include operator authentication information, that is, information of operators who are allowed to perform printing and binding operations using the printer type paper money binding apparatus 100 in order to enhance the security capability of the printer type paper money binding apparatus 100. Operator authentication information stored in the memory 200 preferably includes a password or bio-information. The password may be codes designated by the operator and the bio-information may be fingerprint information or iris information. Operator authentication information may be updated or modified according to the replacement of the operator or operator s intention. Occasionally, in order to further enhance the security capability, both the password and bio-information may be authenticated. Furthermore, in order to change operator authentication information, additional authority may be required. Operator authentication information may be changed only in an external device connected through the interface part 180. Furthermore, operator authentication information may be stored separately from the memory 200.

In a case where the printer type paper money binding apparatus 100 stores operator authentication information in the memory 200 or the like, the controller 150 can be designed to perform the printing and binding operations only if operator authentication information stored in the memory 200 or the like is identical with information inputted through the input part 170 or the interface part 180.

The printer type paper money binding apparatus 100 designed to request operator authentication as explained above may be preferably designed to generate a warning signal if operator authentication information stored in the memory 200 or the like is identical to information inputted through the input part 170 or the interface part 180, and may include an alarm to generate the warning signal.

Occasionally, the controller 150 may be designed to notify inconsistency to a designated device such as a server of the security company via a network, which is connected with the controller 150 by the interface part 180, so that a countermeasure can be taken.

Hereinafter the operation of the printer type paper money binding apparatus of the present invention having the aforementioned structure will be described.

First, the power supply 110 is turned on. In the case of attempting to make an operation instruction, a message requesting operator authentication is displayed on the display 190. After operator authentication information is inputted, if inputted operator authentication information is identical with stored operator authentication information, the next operation is performed. If not identical, a warning signal is generated, or the inconsistency is notified to the security company. Occasionally, in the case where the display 190 is not provided, the printer type paper money binding apparatus 100 may be designed to not operate without the input of an operation instruction signal, even if an operation instruction signal is inputted. Such a process may be omitted if operator authentication information is not stored in the printer type paper money binding apparatus 100.

Then, as paper money is introduced through the money inlet I, the printer 130 prints bundle-of-paper money information stored in the memory 200 on binding strips. If the operator wants to print different information, different information is input into the controller 150 through the input part 170 or the interface part 180, and thus the controller 150 can print the different information.

The controller 150 adjusts the amount of the binding strips, which are accumulated inside the binding apparatus, by controlling the operation of the printer 130 based upon the tension of the binding strips, detected by the sensor, and controls the binder to bind paper money with binding strips printed with bundle-of-paper money information.

Even after a stop signal is inputted, the controller 150 controls the printer 130 and the binder 140 to consume the binding strips, which are already printed but not used yet, as shown in FIG. 3. Alternatively, the binding strips which have been already printed but not used yet can be discharged so that the operator can discard them.

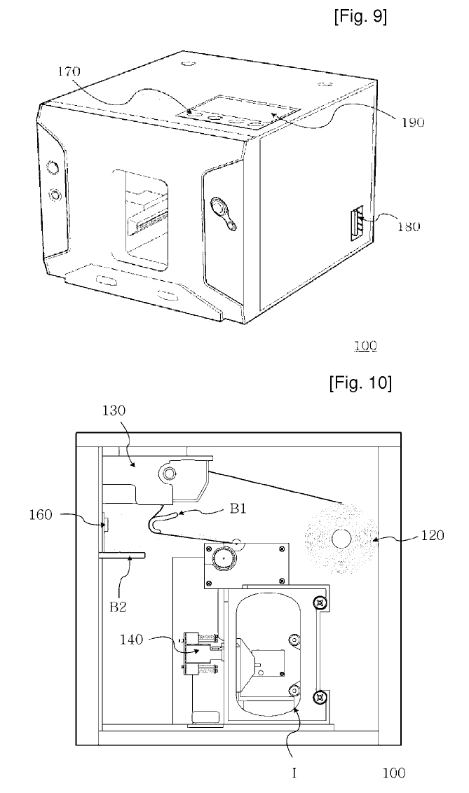

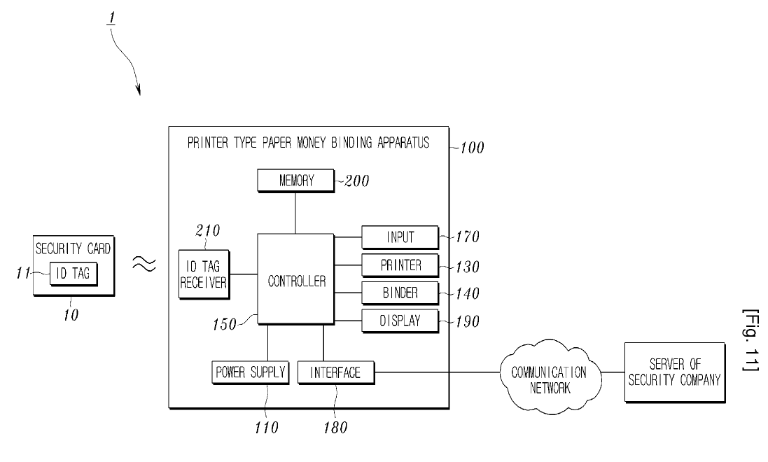

Now the relocation of the components of the printer type paper money binding apparatus 100 of the present invention will be described with reference to FIG. 10.

Describing the relocation of the aforementioned components with reference to FIG. 10, the binding strip storing part 120 takes the position of the printer 130, the printer 130 takes the position of the sensor 160, and the sensor 160 is positioned under the printer 130.

In addition, the printer type paper money binding apparatus 100 further includes a first guide block B1 and a second guide block B2. The first guide block B1 is extended from one side portion of the housing, which faces the money inlet I, into the binding apparatus to a predetermined length in order to guide the binding strips, printed with bundle-of-paper money information, toward the binder 140. The second guide block B2 is extended from one inner side portion of the housing toward the binder 140 to a preset length in order to guide the binding strips, ejected from the printer 130, to the binder through the sensor 160.

In greater detail, as shown in FIG. 10, the binding strips ejected from the printer 130 are introduced into the binder 140 by the first guide block B 1. The binding strips which are not detected by the sensor 160 and thus accumulated inside the binding apparatus are introduced into the binder 140 by the second guide block B2.

According to the aforementioned relocation, it is possible to shorten the path of the binding strips, introduced from the printer 130 to the binder 140, as well as to reduce the size of the printer type paper money binding apparatus 100.

As set forth above, the printer type paper money binding apparatus according to this embodiment of the present invention has unique advantageous features unlike the prior art. That is, the printer type paper money binding apparatus according to this embodiment can bind paper money with the binding strips while printing desired logos, the date, the money unit, the amount of money, and so on. Furthermore, the controller can detect the tension of the binding strips through the sensor and accordingly adjust the operation of the printer.

Next, a printer type paper money binding system capable of authenticating an operator using a security card and an operation thereof according to the present invention will be described.

First, the printer type paper money binding system capable of authenticating an operator using a security card includes a security card 10, a printer type paper money binding apparatus 100 and an external server, such as a security company server as shown in FIG. 11.

The security card 10 includes an identification (ID) tag 11 which stores allowed operator information, i.e., information of an operator allowed to perform a printing and binding operation. Operator information stored in the ID tag 11 may include operator ID information and operator authentication information, and the security card 10 may be issued from a financial institution and the like to a money binding operator, who is allowed to operate the printer type paper money binding apparatus 100.

Accordingly, whenever performing the money binding operation, the operator having the security card 10 inputs operator information A stored in the ID tag of the security card 10, to an ID tag receiver 210 of the printer type paper money binding apparatus 100 by a contact method (e.g., in the case where the ID tag is a magnetic strip) or non-contact method (e.g., in the case where the ID tag is a radio frequency identification (RFID) tag). As will be described below, the printer type paper money binding apparatus 100 performs a controlled paper binding operation by comparing and authenticating operator information A, inputted from the security card 10, with allowed operator information B, which has been previously stored.

The printer type paper money binding apparatus 100 includes the ID tag receiver 210, a memory 200, a power supply 110, a printer 130, a binder 140, a controller 150, an input part 170, an interface part 180, a display 190, and other components (not shown) including an alarm, a sensor and so on as shown in FIG. 11. In this printer type paper money binding apparatus 100, other components except for the ID tag receiver 210 are substantially the same as those explained above, and thus will be described briefly only.

The ID tag receiver 210 functions to receive operator information A stored in the ID tag 11 of the security card 10, via the contact method or the non-contact method, and then transmits received operator information A to the controller 150. In a case where the ID tag of the security card 10 is an RFID tag, the ID tag receiver 210 is realized as an RFID tag receiver.

The memory 200 stores operator information B of operators who are allowed to perform the printing and binding operation, and other various information as explained above. Operator information B includes operator identification information which is used to identify allowed operators, and operator authentication information which is used to authenticate operators. In particular, operator identification information and operator authentication information are preferably stored as a pair. In addition, operator information about all operators who are allowed to operate the printer type paper money binding apparatus 100 is stored in the memory. Operator information can be modified and changed by an authorized personnel.

The printer 130 is controlled to print operator identification information of operator information, stored in the ID tag, and bundle-of-paper money information, such as the bank name, the date, the time, the branch office name, on the binding strips only if two types of information A and B are identical to each other.

When bundle-of-paper money information is printed on a binding strip by the printer 130, the binder 140 binds a preset amount of paper money with the binding strip.

The display 190 may be formed by an LCD screen, which displays the operation such as consistency between two types of information A and B so that the operator can monitor the operation of the printer type paper money binding apparatus 100.

If the two types of information A and B are not identical with each other, the interface part 180 acts to transmit information, that is, notify a bank server or a designated external device, such as a security company server, of the inconsistency through a communication network.

The alarm (not shown) generates a warning signal if the two types of information A and B are not identical to each other.

The power supply 110 supplies necessary electric power to the components of the printer type paper money binding apparatus 100.

The controller 150 searches the memory 200 for allowed operator information, and if operator information B corresponds to operator information A, which is inputted from the ID tag 11 of the security card 10, judges whether or not the two types of information A and B are identical to each other. The controller 150 also controls the operation of the printer 130 and the binder 140 based upon the result of judging whether or not the two types of information A and B are identical with each other. In particular, if operator information inputted from the ID tag of the security card 10 is not identical to operator information stored in the memory of the printer type paper money binding apparatus 100, the controller 150 controls the apparatus in such a manner that a warning signal can be generated or inconsistency can be automatically notified to a security company via a communication network. (Occasionally, it is possible to generate the warning signal while automatically notifying inconsistency to the security company.) In addition, if operator information stored in the memory 200 of the printer type paper money binding apparatus 100 is forged or deleted without authority during the paper money binding operation, the warning signal is generated and the security company is automatically notified. In this time, it is possible to generate the warning signal while automatically notifying the security company of the inconsistency.

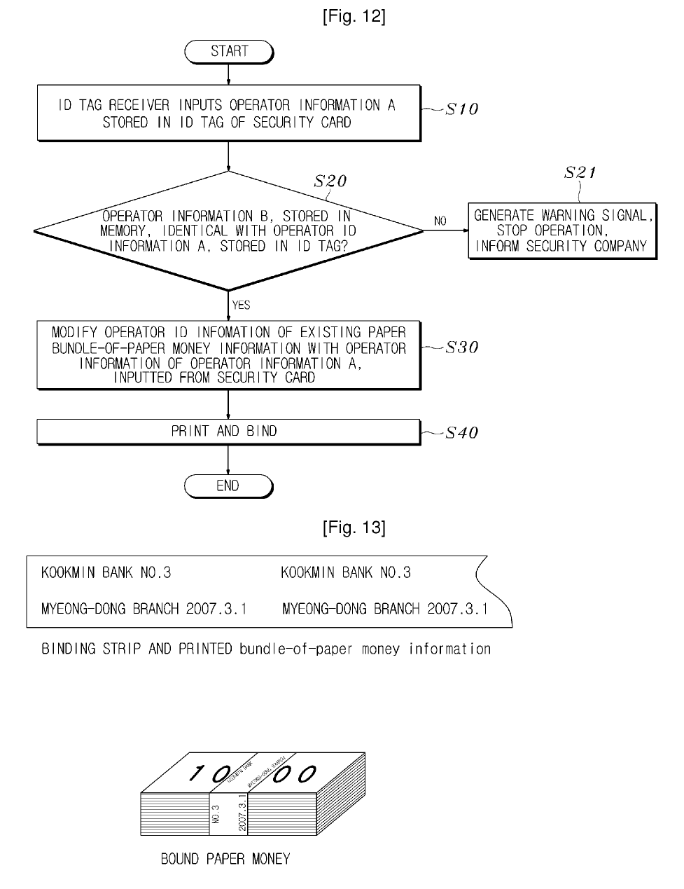

FIG. 12 is a flowchart illustrating a process of the printer type paper money binding system capable of authenticating an operator using a security card having an ID tag inserted therein.

According to the process of the printer type paper money binding system capable of authenticating an operator using a security card having an ID tag inserted therein, as shown in FIG. 12, operator information A, stored in the ID tag 11 of the security card 10, is inputted into the ID tag receiver 210 of the paper money binding apparatus 100 in S10.

Then, operator information A inputted from the ID tag 11 of the security card 10 is compared with operator information B stored in the memory 200 of the printer type paper money binding apparatus 100, that is, information of operators allowed to perform the binding operation in S20. (In S20, operator information B stored in the memory 200 is searched to find information identical with input operator information A.) If two types of information A and B are identical with each other (corresponding to YES in S20), operator identification information of existing money binding information is modified or updated with operator identification information of a corresponding operator (e.g., NO. 3 shown in FIG. 13) in S30.

In S40, operator identification information, which is modified in S30, together with the bank name, the date, the branch office name, etc., are printed on a binding strip and a preset amount of paper money is bound with the binding strip. Then, the operation is finished.

In the meantime, if the two types of information A and B are not identical with each other in S20 (corresponding to NO in step S20), the operation is stopped with a warning signal generated or a security company server is notified of such an inconsistency via a communication network in S21. The procedures in S21 can be carried out sequentially or simultaneously.

In FIG. 12 illustrating the process of binding paper money according to an embodiment of the present invention, operator authentication can be performed using the security card whenever the money binding operation is carried out. Alternatively, the printer type paper money binding apparatus 100 may be designed to automatically lock itself if the printer type paper money binding apparatus 100 is not used for a preset time period, such as 10 minutes or more, in a status where power is turned on, so that the locked status can be disabled only after operator authentication is enabled with the security card. The printer type paper money binding system capable of authenticating an operator of the present invention may be more preferably established in a case where a plurality of operators are allowed to use a single one printer type paper money binding apparatus 100.

Accordingly, the printer type paper money binding system capable of authenticating an operator by using the security card with the ID tag inserted therein and the operation method thereof can ensure security in the binding operation by preventing an unauthorized operator from performing a money binding operation.

Furthermore, operator identification information of the operator who has performed the binding operation is automatically inputted from the security card having the ID tag storing operator information, and is then printed on the binding strip. Thus, it is possible to fundamentally prevent any problem from taking place. Furthermore, since information, such as the bank name, the operator identification information, the branch office name and the date, is printed on the binding strip, the flow of bound paper money can be easily tracked.

It is to be understood that while the present invention has been illustrated and described in relation to several potentially preferred embodiments, constructions and procedures, such embodiments, constructions and procedures are illustrative only and that the present invention is in no event to be limited thereto. Rather, it is contemplated that modifications and variations embodying the principles of the present invention will no doubt occur to those of skill in the art. It is therefore contemplated and intended that the invention shall extend to all such modifications and variations as may incorporate the broad principles of this invention within the full spirit and scope of the claims appended hereto.

### INDUSTRIAL APPLICABILITY

According to the present invention as set forth above, the printer type paper money binding apparatus can print bundle-of-paper money information, such as a logo, the date, the money unit and the amount of money, on the binding strip which is used to bind a bundle of paper money. Furthermore, printer type paper money binding system capable of authenticating an operator and the operation method thereof can prevent an unauthorized operator from performing a printing and binding operation, thereby ensuring security in the printing and binding operation.

1. A printer type paper money binding apparatus, comprising:
a power supply;
a binding strip storing part for receiving binding strips for binding paper money;
a printer for printing bundle-of-paper money information on a binding strip introduced from the binding strip storing part;
a binder for binding paper money using the binding strip, on which the bundle-of-paper money information is printed;
a memory storing various types of information including information necessary for printing the bundle-of-paper money information on the binding strip and binding the paper money; and
a controller for controlling the power supply, the binding strip storing part, the printer, the binder and the memory together with components, which are necessary for printing the bundle-of-paper money information on the binding strip and binding the paper money.

2. The printer type paper money binding apparatus according to claim 1, further comprising:
an input part for inputting the various types of information stored in the memory, or operation instruction signals inputted into the controller; or
an interface part associated with an external device to transmit/receive the information stored in the memory, or the operation instruction signals inputted into the controller, to/from external device.

3. The printer type paper money binding apparatus according to claim 1, further comprising:
an input part for inputting various types of information, stored in the memory, or operation instruction signals inputted into the controller; and
an interface part associated with an external device to transmit/receive the information stored in the memory, or the operation instruction signals inputted into the controller, to/from external device.

4. The printer type paper money binding apparatus according to claim 1, wherein the printer comprises:
a counter module for measuring present date and time; and
a printer module for receiving the bundle-of-paper money information from the memory and printing the bundle-of-paper money information on the binding strip.

5. The printer type paper money binding apparatus according to claim 1, further comprising a sensor for detecting a pressure on the binding strips ejected from the printer,
wherein the controller controls an operation of the printer based upon a detection signal from the sensor in order to adjust an amount of the binding strips, which are accumulated, thereby preventing damage to the binding strips.

6. The printer type paper money binding apparatus according to claim 1, further comprising a display for displaying the various types of information including the bundle-of-paper money information stored in the memory.

7. The printer type paper money binding apparatus according to claim 6, wherein the display has a function of a touch screen.

8. The printer type paper money binding apparatus according to claim 1, wherein the controller makes a control to discharge a remaining portion of the binding strips which have been already printed but not used yet, when the power supply is turned off.

9. The printer type paper money binding apparatus according to claim 1, wherein the controller controls the printer and the binder to consume a remaining portion of the binding strips which have been already printed but not used yet, even though a stop signal is inputted.

10. The printer type paper money binding apparatus according to claim 1, wherein the various types of information stored in the memory further comprise operator authentication information of operators who are allowed to perform a printing and binding operation using the printer type paper money binding apparatus.

11. The printer type paper money binding apparatus according to claim 10, wherein the operator authentication information stored in the memory is password or bio-information.

12. The printer type paper money binding apparatus according to claim 10, further comprising an alarm for generating a warning signal if the operator authentication information stored in the memory is not identical with information which is inputted through the input part or the interface part.

13. The printer type paper money binding apparatus according to claim 10, wherein the controller sends an inconsistency signal to a designated external device via a communication network, the controller connected to the communication network by the interface, if the operator authentication information stored in the memory is not identical with information which is inputted through the input part or the interface part.

14. The printer type paper money binding apparatus according to claim 10, wherein the controller makes a control to perform the printing and binding operation only if the operator authentication information stored in the memory is identical with information which is inputted through the input part or the interface part.

15. A printer type paper money binding system capable of authenticating an operator, comprising:
a security card having an identification (ID) tag storing operator information including printing-binding operator information and operator authentication information; and
a printer type paper money binding apparatus including:
an ID tag receiver for receiving the operator information, stored in the ID tag, via a contact or non-contact method;
a memory storing various types of information including operator information of operators, who are allowed to perform a printing and binding operation, and information necessary for printing bundle-of-paper money information and binding paper money; and
a controller for comparing the operator information stored in the ID tag of the security card with the operator information stored in the memory, in order to control components which are necessary for printing the bundle-of-paper money information on a binding strip and binding the paper money, based upon consistency between the operator information stored in the ID tag of the security card and the operator information stored in the memory.

16. The printer type paper money binding system according to claim 15, wherein the controller controls the apparatus to generate a warning signal or automatically send an inconsistency signal to a designated device via a communication network if the operator information stored in the memory is forged or deleted without authority during the operation of binding the paper money.

17. The printer type paper money binding system according to claim 15, wherein the controller sends an inconsistency signal to a security company via a communication network if the operator information stored in the ID tag of the security card is not identical with the operator information stored in the memory.

18. The printer type paper money binding system according to claim 15, wherein the binding strip is printed with operator identification information, bank name, date and branch office name.

19. The printer type paper money binding system according to claim 15, wherein the ID tag is a radio frequency identification (RFID) tag, and the ID tag receiver is an RFID tag receiver.

20. A method of operating a printer type paper money binding system capable of authenticating an operator, which comprises a security card having an identification (ID) tag inserted therein and a printer type paper money binding apparatus, comprising steps of:
(a) at an ID tag receiver of the paper money binding apparatus, receiving operator information including operator identification information and authentication information stored in the ID tag of the security card;
(b) comparing the operator information stored in the ID tag of the security card with operator information of operators, who are allowed to performing a binding and binding operation, stored in the memory; and
(c) controlling an authority over the money binding apparatus based upon a result of the comparing step (b) in order to carry out the printing and binding operation.

21. The method according to claim 20, further comprising: generating a warning signal and stopping a process, if the operator information stored in the ID tag of the security card is not identical with the operator information, stored in the memory as the result of the comparing step (b).

22. The method according to claim 20, further comprising: sending an inconsistency signal to a security company server via a communication network, if the operator information stored in the ID tag of the security card is not identical with the operator information stored in the memory as the result of the comparing step (b).

23. The method according to claim 20, comprising: printing the operator identification information of the operator information and information including bank name, date and branch office name on a binding strip and binding paper money with the printed binding strip if the operator information stored in the ID tag of the security card is identical with the operator information stored in the memory as the result of the comparing step (b).
